(19) United States
(12) Patent Application Publication
(10) Pub. No.: US 2007/0084003 A1
(43) Pub. Date: Apr. 19, 2007

(54) Device for removing loose pet hair strands and method thereof

(76) Inventors: Kelly C. Straub, Grand Forks, ND (US); Emily C. Straub, Grand Forks, ND (US)

Correspondence Address: JAMES RAY & ASSOCIATES, 2640 PITCAIRN ROAD, MONROEVILLE, PA, 15146, US

(21) Appl. No.: 11/583,519

(22) Filed: Oct. 18, 2006

Related U.S. Application Data
(60) Provisional application No. 60/728,056, filed on Oct. 19, 2005.

(51) Int. Cl. D06G 1/00; A01K 13/00

(52) U.S. Cl. 15/40; 119/609

(57) ABSTRACT

The invention provides a hand held device for removing loose hair strands from at least one of a pet and a fabric which includes a handle member, a hair removal member having a material from a group consisting of natural rubber, synthetic rubber, vinyl, gum and silicone and adhesive for attaching said hair removal member to said handle member. The invention further provides an accessory for a conventional power operated tool or a vacuum cleaner which is usable for removing loose hair strands.

### CROSS-REFERENCE TO RELATED APPLICATIONS

This application is related to and claims priority from Provisional Patent Application Ser. No. 60/728,056 filed Oct. 19, 2005.

### FIELD OF THE INVENTION

The present invention relates, in general, to loose hair collection and, more particularly, this invention relates to a device for removing loose hair strands directly from the pet or from the surface that the pet comes in contact with.

### BACKGROUND OF THE INVENTION

As is generally well known, the majority of the common house pet breeds shed at least some hair and many shed a great deal of hair. The loose hair accumulates on a variety of fabric surfaces, such as floor coverings, upholstery, furniture, vehicle seats, clothing and the like that the pet comes in contact with. Prior to the present invention, hand held devices such as vacuum cleaners, brushes, adhesive sheets and adhesive rollers are employed for removing the loose hair strands from various surfaces and brushes are generally employed for removing the loose hair directly from the pet during grooming effort. However, one problem that is continuously experienced by pet owners removing loose hair from the fabric is in extreme difficulty in removing loose hair strands which are embedded into fabric fibers since the conventional tools are not capable of removing such embedded hair strands.

There is a need for a device for removing loose pet hair strands which are embedded into the fabric fibers.

### SUMMARY OF THE INVENTION

According to one embodiment, the invention provides a hand held device for removing loose hair strands from at least one of a pet and a fabric. The hand held device includes a handle member. There is a hair removal member which has a material from a group consisting of natural rubber, synthetic rubber, vinyl, gum and silicone. Means is provided for attaching the hair removal member to the handle member.

According to another embodiment of the invention, there is provided a method of removing loose hair strands from at least one of a pet and a fabric. The method includes the step of providing a device which includes a hair removal member having a material from the group consisting of natural rubber, synthetic rubber, vinyl, gum and silicone. Next, positioning the hair removal member for a contact with the at least one of pet and fabric. Then, operably moving the device in a predetermined pattern relative to the at least one of pet and fabric.

According to yet another embodiment, the invention provides in combination with a power operated apparatus, an accessory device for removing loose hair strands from at least one of a pet and a fabric. The accessory device includes a base member. A first attachment means is provided for detachably attaching the base member to such apparatus. There is a hair removal member which has a material from a group consisting of natural rubber, synthetic rubber, vinyl, gum and silicone. A second attachment means is provided for attaching the hair removal member to the base member.

According to a further embodiment of the invention, there is provided in combination with a vacuum cleaner having a powerhead for generating a suction airflow, an improvement comprising a member mounted within such powerhead for removing loose hair strands. The member-includes a material from a group consisting of natural rubber, synthetic rubber, vinyl, gum and silicone.

### OBJECTS OF THE INVENTION

It is, therefore, one of the primary objects of the present invention to provide a device for removing loose hair strands.

Another object of the present invention is to provide a device for removing loose hair strands which is usable on a pet and a fabric.

Yet another object of the present invention is to provide a device for removing loose hair strands in a residue-free fashion.

A further object of the present invention is to provide a device for removing loose hair strands which employs a material from a group consisting of natural rubber, synthetic rubber, vinyl, gum or silicone.

Yet a further object of the present invention is to provide a device for removing loose hair strands which is attachable to a conventional power operated tools.

An additional object of the present invention is to provide a vacuum cleaner accessory for removing loose hair strands which includes a material from a group consisting of natural rubber, synthetic rubber, vinyl, gum or silicone.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a perspective view of a device for removing loose hair strands constructed according to one embodiment of the invention;

FIG. 2 is a perspective view of a device for removing loose hair strands constructed according to another embodiment of the invention in combination with a hand held power operated tool;

FIG. 3 is a perspective view of a device for removing loose hair strands constructed according to yet another embodiment which is which attachable to conventional vacuum cleaners;

FIG. 4 is a cross-sectional view of the device for removing loose hair strands along lines 4-4 of FIG. 3; and

FIG. 5 is a partial side elevation view of a vacuum cleaner employing a device for removing loose hair strands.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

According to a first embodiment, the invention provides a hand held device, generally designated as 10, for removing loose pet hair strands from at least one of a pet and a fabric. It is to be understood that the definition of the fabric includes but is not limited to floor coverings, upholstery, furniture, vehicle seats, clothing and the like that the pet comes in contact with.

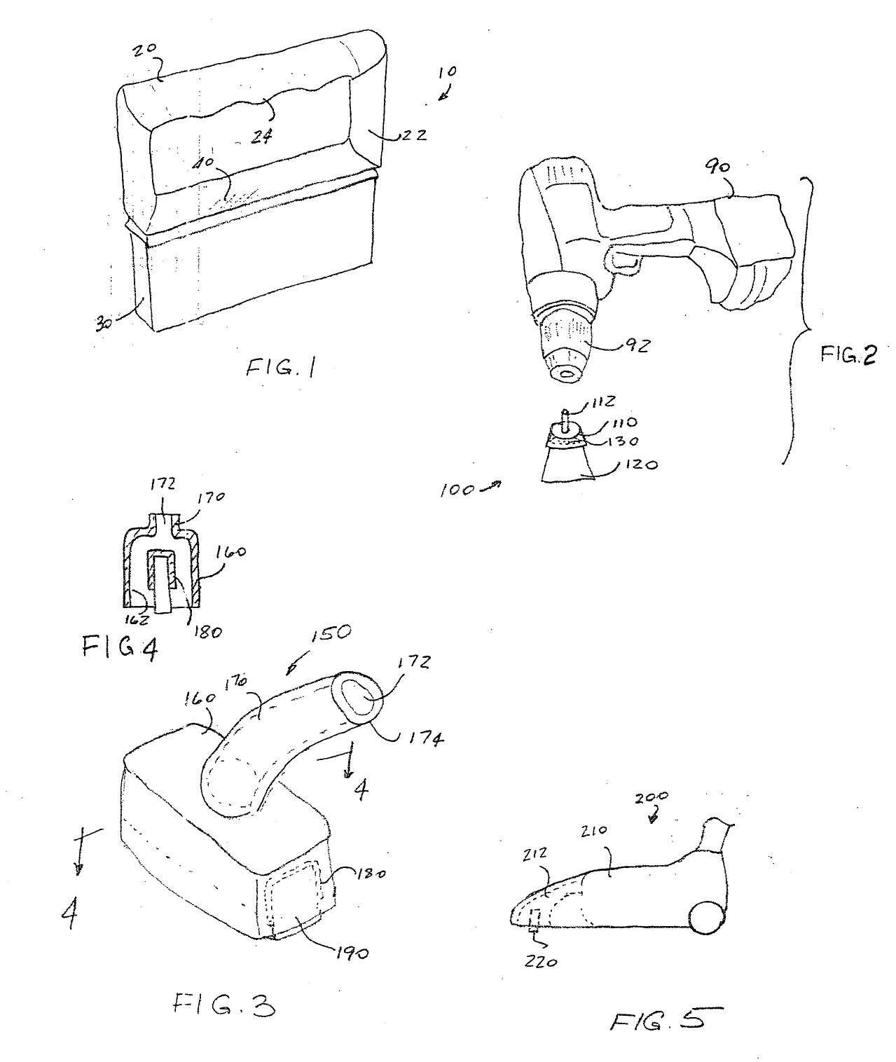

Reference is now made, to FIG. 1, wherein the device 10 includes a handle member 20, a hair removal member 30 which has a material from a group consisting of natural rubber, synthetic rubber, vinyl, gum or silicone and means 40 for attaching the hair removal member 30 to the handle member 20.

It is presently preferred that the handle member 20 has a generally rectangular hollow frame 22 profile and the hair removal member 30 is attached to one edge of the hollow frame 22. The material of the handle member 20 is one of plastic, wood, metal and various combinations thereof.

An optional grip means 24 may be formed on an edge of the hollow frame 22 which is positioned oppositely from the edge having the hair removal member 30 attached thereto. Such grip means 24 preferably includes a plurality of curvilinear finger ridges 26 formed internal to the hollow frame 22. It is further presently preferred for the finger grip means 24 to be formed integral to the handle member 20. It would be appreciated that the handle member 20 in combination with the finger grip means 24 may be economically formed from a plastic material by a molding process.

The invention also contemplates for the finger grip means 24 to be formed from a soft-grip thermoplastic elastomer or rubber material, such as Adflex grade material, which provides for safe and comfortable handling of the device 10. Such soft-grip thermoplastic elastomer or rubber material is now commonly used on hand tools.

The hair removal member 30 is allowed to flex about its attachment to the handle member 20 for removing such loose pet hair strands. In the presently preferred embodiment of the invention, the hair removal member 30 is made from the gum material which is capable of removing such hair strands from such fabric in a residue-free fashion. Such gum material is substantially identical to a material presently used in a gum eraser which can be purchased from Kmart Corporation under a “School Select” brand name. It has been found that such particular material is advantageous for removing loose hair strands embedded into the fabric fibers in a residue-free fashion. It has been also found that this material is adequately removes loose hair stands from the pet without causing discomfort to the pet and therefore is suitable for pet grooming.

The presently preferred attachment means 40 is an adhesive and, more particularly, a contact cement adhesive.

In use for removing loose hair strands from the fabric fibers, the hair removal member 30 is positioned for contact with such fabric and is operable, preferably in a sweeping motion, to collect loose hairs strands in a predetermined portion of such fabric for pick-up and disposal.

It is presently preferred for such hair removal member 30 to have a rectangular shape which has been found advantageous in removing loose hair strands from corners formed by two surfaces for example, such as automobile seat, or around buttons, seems and fabric corners.

For using such device 10 on pets, the pet owner uses simple linearly directional strokes to removing loose hair strands from the pet.

Although the present invention has been shown in terms of the hand held device 10 having a rectangular shaped handle and hair removal members, it will be apparent to those skilled in the art, that other shapes of such members may be applied in the present invention. For example, the handle member may be formed as an elongated member to enable ease of removing loose hair strands from floor coverings, such as rugs and carpets, without requiring the user to bend down.

According to a second embodiment, the present invention provides in combination with a power operated apparatus 90, a device, generally designated as 100, for removing loose pet hair strands from at least one of a pet and a fabric. Now in reference to FIG. 2, the device 100 includes a base member 110 and a first attachment means 112 for detachably attaching the base member 110 to such apparatus 90.

The device 110 further includes a hair removal member 120 which has a material from a group consisting of natural rubber, synthetic rubber, vinyl, gum or silicone. A second attachment means 130, such as contact cement adhesive, is provided for attaching the hair removal member 120 to the base member 110.

By way of example of FIG. 2, the apparatus 90 is illustrated as a well known hand held power drill 90 having a tool retaining chuck 92 and the first attachment means 112 is illustrated as a simple shaft like member 112 which extends outwardly from one end of the base member 110.

The hair removal member 120 is illustrated in FIG. 2 as having a frustoconical shape, although other shapes may be employed in the present invention.

In use, the shaft like member 112 is clamped within such chuck 92 for attaching the device 100 to the apparatus 90. The hair removal member 120 is then positioned for contact with the pet or fabric and the power tool 90 is activated to rotate the hair removal member 120, The power tool 90 is moved in a predetermined pattern, which is generally similar to the pattern employed with use of the hand held device 10 described supra to collect the loose hair strands for pick-up and disposal.

According to yet another embodiment of the invention, best illustrated in FIGS. 3-4, there is shown an accessory device, generally designated as 150, for a vacuum cleaner which is employed for removing loose hair strands. The device 150 includes a base member 160, which is formed as a generally hollow housing. A rigid member 170 is formed integral with the housing 160 and has a passageway 172 in open communication with the hollow portion 162 of the housing 160. The free end 174 of the rigid member 170 is adapted for attachment to a nuzzle or to the a removable nuzzle extension (not shown) in a conventional manner. A U-shaped member 180 is positioned within the hollow member 162 and, preferably formed integral with the housing 160 for receiving a member 190 including a material from a group consisting of natural rubber, synthetic rubber, vinyl, gum or silicone. A contact cement adhesive may be employed for retaining the member 190 within the U-shape member 180.

According to a further embodiment of the invention, illustrated in FIG. 5, there is provided a vacuum cleaner, generally designated as 200, which includes a powerhead 210 for generating a suction airflow. A member 220, including a material from a group consisting of natural rubber, synthetic rubber, vinyl, gum or silicone, is mounted within the air passageway 212 of the powerhead 210 for aiding in removal of loose hair strands. It has been found that a pull motion is advantageous in removing embedded loose hair strands from the fabric.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

We claim:

1. A hand held device for removing loose hair strands from at least one of a pet and a fabric, said device comprising:
(a) a handle member;
(b) a hair removal member which has a material from a group consisting of natural rubber, synthetic rubber, vinyl, gum and silicone; and
(c) means for attaching said hair removal member to said handle member.

2. The device, according to claim 1, wherein said handle member includes a generally rectangular hollow frame profile and wherein said hair removal member is attached to one edge of said hollow frame.

3. The device, according to claim 2, wherein said handle member further includes a grip means which is formed on an edge of said hollow frame positioned oppositely from said edge having said hair removal member attached thereto.

4. The device, according to claim 3, wherein said grip means includes a plurality of curvilinear finger ridges formed internal to said hollow frame.

5. The device, according to claim 1, wherein a material of said handle member is one of plastic, wood, metal and various combinations thereof.

6. The device, according to claim 1, wherein a material of said handle member is a plastic and wherein said handle member includes a finger grip means which is formed integral to said handle member.

7. The device, according to claim 6, wherein said handle member is manufactured by a molding process and wherein said finger grip means is formed integral to said handle member during said molding process.

8. The device, according to claim 1, wherein said hair removal member is allowed to flex about its attachment to said handle member for removing such loose hair strands.

9. The device, according to claim 1, wherein said material of said hair removal member is said gum which removes such loose hair strands from such fabric in a residue-free fashion.

10. The device, according to claim 1, wherein said attachment means includes an adhesive.

11. A method of removing loose hair strands from at least one of a pet and a fabric, said method comprising the steps of:
(a) providing a device which includes a hair removal member having a material from the group consisting of natural rubber, synthetic rubber, vinyl, gum and silicone;
(b) positioning said hair removal member for a contact with said at least one of pet and fabric; and
(c) operably moving said device, provided in step (a) and positioned for said contact in step (b), in a predetermined pattern relative to said at least one of pet and fabric.

12. The method, according to claim 11, wherein said device is manually moved in step (c).

13. The method, according to claim 11, wherein said device is attached to a power operated apparatus.

14. In combination with a power operated apparatus, an accessory device for removing loose hair strands from at least one of a pet and a fabric, said accessory device comprising:
(a) a base member;
(b) a first attachment means for detachably attaching said base member to such apparatus;
(c) a hair removal member which has a material from a group consisting of natural rubber, synthetic rubber, vinyl, gum and silicone; and
(d) a second attachment means for attaching said hair removal member to said base member.

15. The combination, according to claim 14, wherein such power operated apparatus is a hand held power tool having a tool retaining chuck and wherein said first attachment means is a shaft like member extending outwardly from one end surface of said base member, whereby said device is attached to such apparatus by clamping said shaft like member within such chuck.

16. The combination, according to claim 14, wherein such power operated apparatus includes a vacuum cleaner and such first attachment means includes a rigid member which is formed integral with said base member for attaching it to one of a suction nozzle and a removable nozzle adapter of such vacuum cleaner and an air passageway formed within said rigid member in communication with such one of such nozzle and such removable nozzle adapted, whereby said loose hair strands removed by said hair removal member are sucked in by such vacuum cleaner.

17. In a vacuum cleaner having a powerhead for generating a suction airflow an improvement comprising a member mounted within such powerhead for removing loose hair strands, said member including a material from a group consisting of natural rubber, synthetic rubber, vinyl, gum and silicone.
